(19) United States
(12) Patent Application Publication
(10) Pub. No.: US 2008/0166476 A1
(43) Pub. Date: Jul. 10, 2008

(54) MAGNETO-OPTICAL LAYER

(75) Inventors: Jun AKEDO, Ibaraki (JP); Jaehyuk Park, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: National Institute of Advanced Industrial Science and Technology, Tokyo (JP)

(21) Appl. No.: 11/959,834

(22) Filed: Dec. 19, 2007

Related U.S. Application Data
(60) Provisional application No. 60/878,698, filed on Jan. 5, 2007.

(51) Int. Cl. B05D 5/12; B05D 1/12; B05B 7/04

(52) U.S. Cl. 427/128; 118/308; 427/180

(57) ABSTRACT

A method of forming a room-temperature deposited and transparent magneto-optic layer includes depositing a transparent magnetic nanocomposite layer with embedded nanomagnetic particles in matrix onto substrates by aerosol deposition method at room-temperature.

### BACKGROUND OF THE INVENTION

1. Technical Field

The present invention relates to a magneto-optic layer, and more particularly, to a room-temperature deposited, transparent magnetic nanocomposite layer with embedded nanomagnetic particles in matrix onto substrates by an aerosol deposition method at room-temperature, and method of manufacturing the same.

2. Related Art

In the related art, materials containing particles of nanometer dimensions have shown interesting properties related to its extremely small size. For example, some of their optical, magnetic, electronic, mechanical, and chemical properties are different from properties exhibited by the same composition in bulk material.

More specifically, magnetic nanoparticles have become a subject of growing related art interest, and intense research is being conducted. An attractive property of the transparent magnetic nanocomposite layer is very closely related to the magneto-optical effects. The scientific as well as industrial applications for this technology includes optical fiber sensors, optical switches, optical isolators and information storage.

Nanocomposite films have been prepared using various related art methods, including sputtering, sol-gel, colloidal solutions, ion implantation, Chemical Vapor Deposition (CVD) and other methods. According to the related art methods, it is very difficult to controlling the size and shape of the nanomagnetic particles in the host matrix. For example, it may be difficult to acquire a spatial distribution and control the concentration of the nanomagnetic particles in the host matrix.

Further, the related art method of manufacture requires a high temperature annealing processes of more than 600° C. and it may be difficult to prepare highly transparent and thick nanocomposite films with a thickness of several microns. Moreover, the related art lacks a use for the complex oxide with multi-composition elements as a host matrix.

Therefore, there remains a long felt but unmet need in the related art for an magneto-optic layer, particularly a transparent magnetic nanocomposites thick layer, that addresses the foregoing related art considerations, and a spatial distribution of nanomagnetic particles, as well as a low temperature annealing processes and a method of manufacturing the same.

### SUMMARY OF THE INVENTION

The exemplary embodiments include a system for generating a nanocomposite layer on a substrate, comprising an aerosol chamber configured to accept a carrier gas and a powder of a sub-micron size, and to generate an aerosol, and a deposition chamber configured to accelerate said aerosol via a nozzle to solidify onto a substrate and produce a film that includes fine crystal grains without any pores, having a size of tens of nanometers, wherein said deposition chamber operates at room temperature.

Further, the exemplary embodiments include a method of forming a nanocomposite layer on a substrate, comprising mixing a carrier gas and a powder of sub-micron size to generate an aerosol, and accelerating and depositing said aerosol to solidify onto a substrate and produce a film that includes fine crystal grains without any pores, having a size of tens of nanometers, wherein said deposition chamber operates at room temperature.

### BRIEF DESCRIPTION OF THE DRAWINGS

The above and other features and aspects will become more apparent by describing in detail exemplary embodiments thereof with reference to the attached drawings in which:

FIG. 1 is an illustration of an aerosol deposition (AD) system for preparing magnetic nanocomposite layer according to an exemplary embodiment;

FIG. 2 is an illustration of a schematic of new concept for the preparation of nanocomposite systems with an AD method according to the exemplary embodiment;

FIG. 3 is a field emission scanning electron microscope (FE-SEM) picture of a nanocomposite powder of lead zirconate titanate (PZT) powder and nano particles of cobalt according to an exemplary embodiment;

FIG. 4 illustrates a cross-sectional view of a transparent magnetic nanocomposite layer formed by the AD method according to an exemplary embodiment;

FIG. 5 is a transmission electron microscope (TEM) picture of a PZT/cobalt nanocomposite layer according to an exemplary embodiment;

FIG. 6 is an energy dispersive X-ray (EDX) picture of cobalt element in PZT/cobalt nanocomposite layer according to an exemplary embodiment;

FIG. 7 illustrates plots of (a) transmittance spectra and (b) transmittance value of 0.005, 0.02, 0.05 and 0.1 wt % nanocobalt-containing nanocomposite cobalt/PZT layer according to an exemplary embodiment; and

FIG. 8 illustrates a plot of (a) Faraday rotation hysteresis loop and (b) Faraday rotation angle of 0.005, 0.02, 0.05 and 0.1 wt % nanocobalt-containing nanocomposite cobalt/PZT layer at 532 nm, according to the exemplary embodiment.

### DETAILED DESCRIPTION OF THE INVENTION

Hereinafter, exemplary embodiments of the present invention will be described in detail with reference to the attached drawings. A novel ceramic film-forming method an aerosol deposition has been developed.

Accordingly, the AD method is a film-forming method based on an impact consolidation phenomenon, and utilizes the phenomenon of collision and coalescence of ultra fine particles. The starting powders of sub-micron size are mixed with a carrier gas to form an aerosol flow in the aerosol chamber. The aerosol flow is transported through a tube to a nozzle, and then accelerated and ejected from the nozzle into a deposition chamber by the pressure difference between the aerosol chamber and the deposition chamber. Since AD method involves solidification by impact of accelerated sub-micron particles onto a substrate, AD films consist of fine crystal grains of several tens of nanometers in diameter without any pores.

The AD method has characteristics of the fabrication of thick oxide films with a high deposition rate and a low process temperature on different kinds of substrates. Also, the AD method makes use of crystalline fine particles with multi-composition as raw materials and has no change of original composition from starting materials before and after coating, compared to related art coating method including sputter, sol-gel and CVD. (see Jun Akedo and Maxim Lebedev, “MATERIA”41, (2002), P. 459 and Jun Akedo and Maxim Lebedev, Jpn. J. Appl. Phys. 38, (1999), P. 5397).

In this exemplary embodiment, a fabrication of a room-temperature deposited transparent magneto-optic layer and more particularly a transparent magnetic nanocomposites layer with embedded nanomagnetic particles in matrix onto substrates by aerosol deposition method at a room-temperature, is provided.

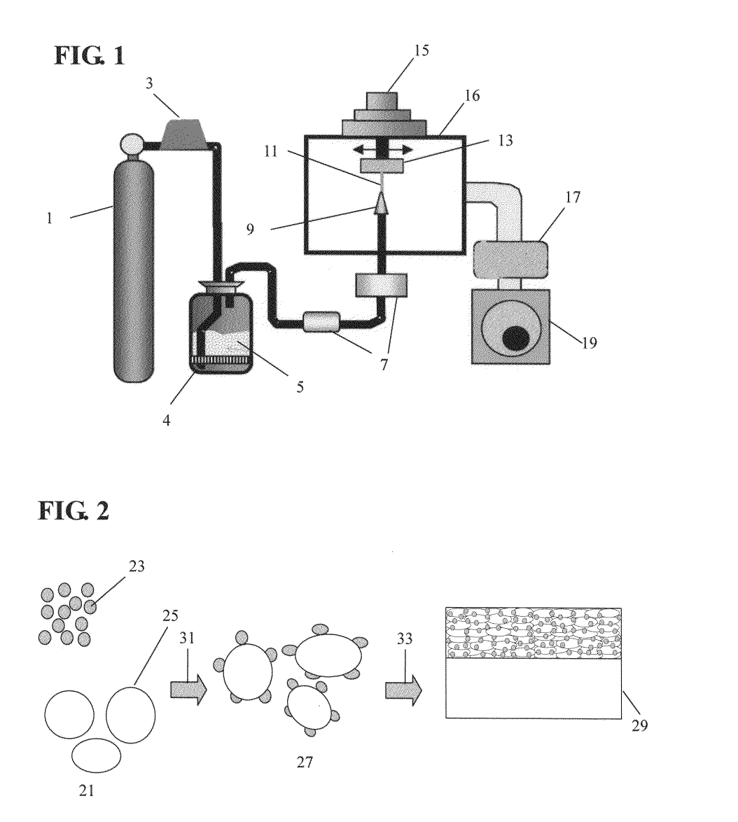

FIG. 1 shows an illustration of an AD system for preparing magnetic nanocomposite layer according to an exemplary embodiment. For example, a gas cylinder 1 contains a carrier gas, and is connected to an aerosol chamber 4 that contains a starting powder 5 of sub-micron size. A mass flow controller 3 is positioned between the gas cylinder 1 and the aerosol chamber 4. The mixed aerosol travels from the aerosol chamber 4 to a nozzle 9 via a filter and classificator along a tube 7. The aerosol is then accelerated into a particle beam 11 and attached to a substrate 13 that is connected to a stage 15 within a deposition chamber 16. A mechanical pump 17 and a rotary pump 19 are also provided for maintaining an environment in the deposition chamber 16.

FIG. 2 shows a schematic for the preparation of nanocomposite systems with the AD method. Since the AD method can make a itself structure of composite powder as a dense thick layer as described above, the exemplary embodiment for the preparation of nanocomposite systems with AD method has many merits. For example but not by way of limitation, the exemplary embodiment can further apply various sizes of nanomagnetic particles from about 5 nm to 500 nm, and achieves desirable distribution of nanomagnetic particles in dielectric matrix because the structure of deposited layer is similar to that of composite powder. The AD method can tailor desired concentration of nanomagnetic particles in host matrix by just controlling an amount of the given nanomagnetic particles mixing with host matrix particles.

As shown in FIG. 2, raw powder 21 includes a nanomagnetic particle 23 and a host matrix particle 25. After mixing 31 is performed at the aerosol chamber 4, a composite powder 27 is generated, in which the nanomagnetic particle 23 is attached to the host matrix particle 25. After coating 33 is performed in the deposition chamber 16, a transparent magnetic nanocomposite layer 29 is formed via room temperature deposition.

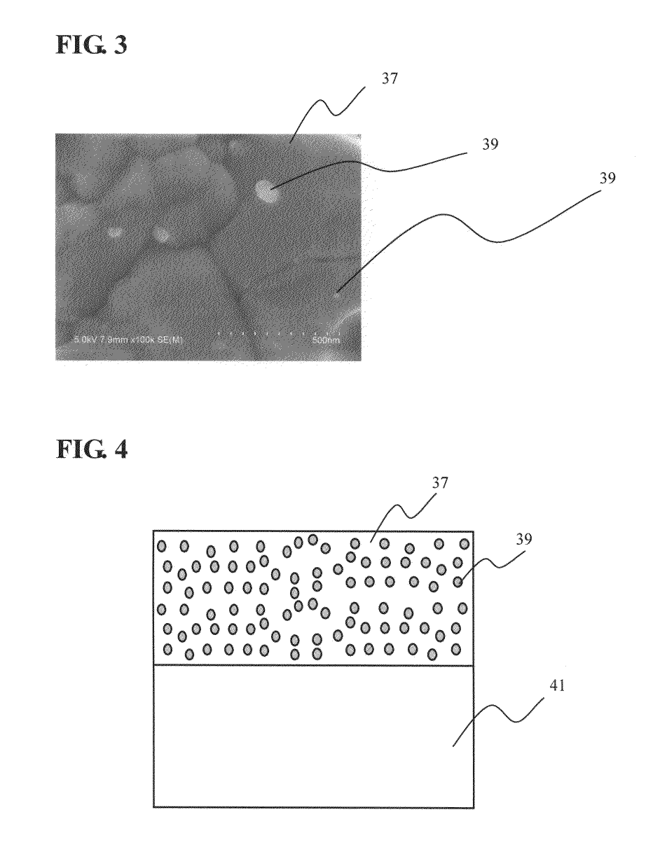

For preparing nanocomposite films, a composite metal-dielectric powder is prepared from PZT (Zr/Ti=52/48) powder 37 and nano particles 39 of cobalt (20-50 nm), as shown in FIGS. 3 and 4. The size of PZT is approximately 200-500 nm. The concentrations of nanocobalts are about 0 to 10 wt %. Transparent magnetic nanocomposites layer was directly deposited on glass substrate 41 at room temperature by AD method using composite magnetic-dielectric powder, as shown in FIGS. 3 and 4. Referring FIG. 4, the typical layer thickness was about 1-10 μm with process conditions of 4-6 L/min of N2 gas, a deposition time of about 3-5 min. Nanocomposite cobalt/PZT layers are then annealed at various temperatures.

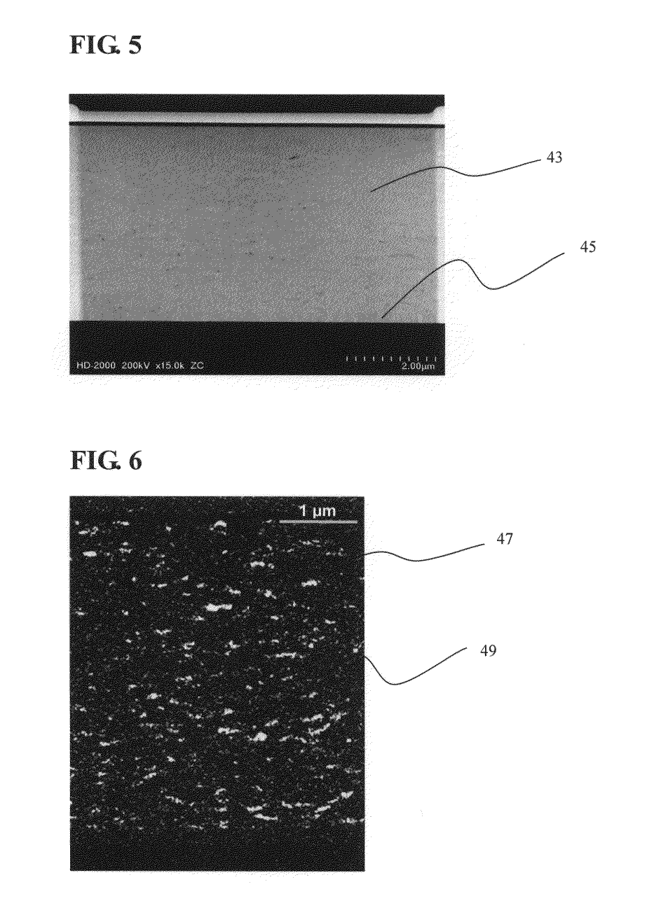

Referring to FIG. 5, the cobalt/PZT nanocomposite thick layer 43 on substrate 45 could obtain no cracks and display very dense without any pores. The nanocobalt particles 47 have good spatial distribution in PZT matrix 49, as shown in FIG. 6. The size of nanocobalt particles are from about 20 nm to less than about 150 nm.

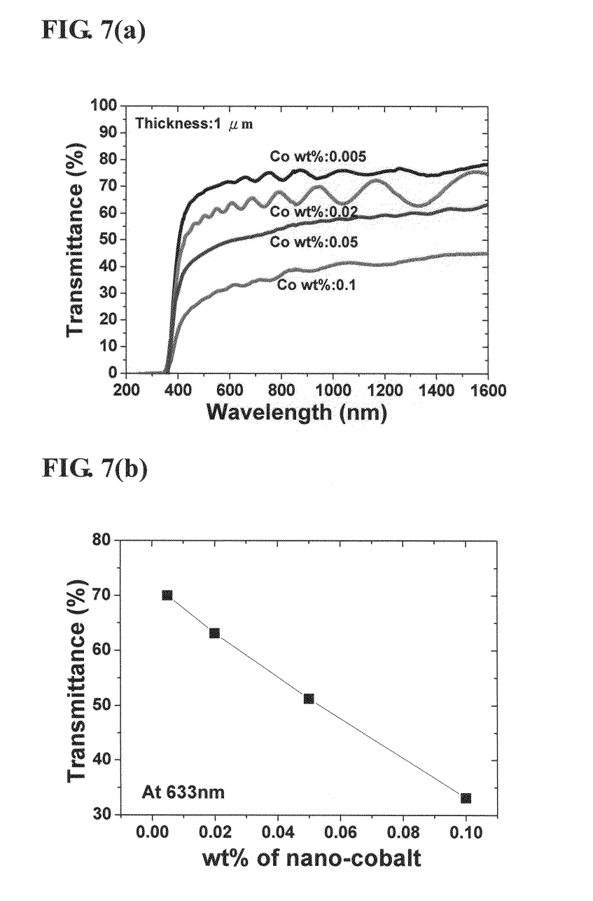

FIG. 7 shows a plot of (a) transmittance spectra and (b) transmittance value of 0.005, 0.02, 0.05 and 0.1 wt % nanocobalt-containing nanocomposite cobalt/PZT layer. All specimens are room-temperatured-deposited. The colors of each specimens are very light brown to deep brown with the increase of cobalt wt % concentration, as shown in FIG. 7(a). The optical properties of 0.005 wt % nanocobalt-containing nanocomposite cobalt/PZT layer are similar to pure PZT films. As the wt % of nanocobalt increased, transmittance of nanocomposite layers at 633 nm gradually decreases with good linearity. Accordingly, nanocobalt particles were spatially distributed in the PZT matrix and optical transmittance of the nanocomposite films could be precisely controlled by adjusting the concentration of nanocobalt in the host matrix.

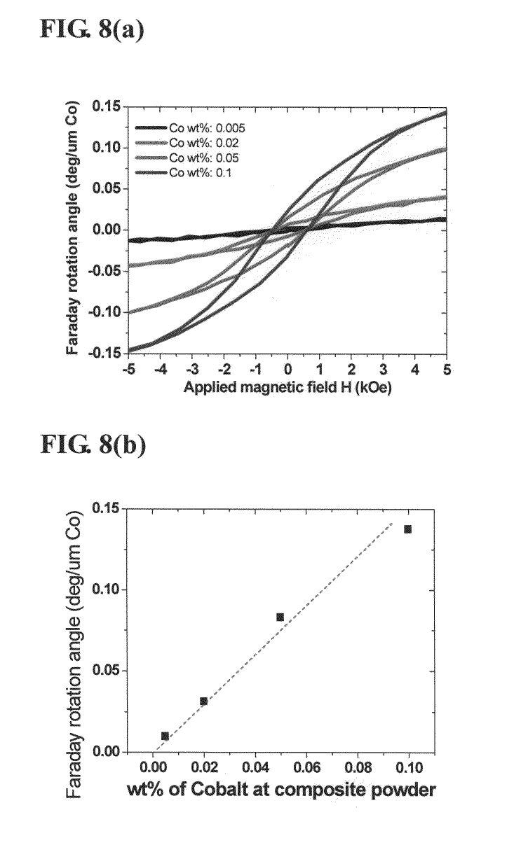

FIG. 8 show a plot of (a) Faraday rotation hysteresis loop and (b) Faraday rotation angle of 0.005, 0.02, 0.05 and 0.1 wt % nanocobalt-containing nanocomposite cobalt/PZT layer at 532 nm. As the wt % of nanocobalt increased, magneto-optic effect, especially Faraday rotation effect of nanocomposite layers gradually increases with linearity.

After room-temperature deposition, a thermal annealing process can be employed to affect a crystallization of host matrix or magnetic properties of nanomagnetic particles wherein nanoparticles of cobalt are fixed in the PZT matrix. The annealing temperature depends upon the ambient type and annealing method. For example, a related art furnace anneal may be used at a temperature between about 100 to 800 degree C., and optionally around 400 to 600 degree C., for a period of about 3 to 10 minutes or longer, depending upon the temperature, and optionally in an non-oxidization or vacuum ambience. A rapid thermal anneal between about 20 to 100 seconds at about 300 to 900 degrees C. may also be employed. Still further, a pulsed laser anneal for a short time period, e.g., less than 30 seconds, at a relatively high temperature, e.g., greater than 600 degrees C., may also be employed. The total pressure may range from a few mTorr to 1.0 atm.

It is contemplated that other nano-magnetic metal particles (besides cobalt) such as iron, nickel, and Mn etc., as well as nano-magnetic oxide particles such as ferrite and garnet, optionally less than 10 wt %, and more preferably in the range of 0.001 to 1 wt %, could also provide the same results without departing from the scope of the invention. Still further, some alloy nano-metal magnetic particles such as NiFe, CoPt, and FePt, etc., as well as composite of nano-magnetic oxide particles and nano-magnetic metal particles may also be used.

It is also contemplated that other host oxide matrix (besides PZT) including dielectric, ferroelectric, ferromagnetic oxide such as SiO₂, Al₂O₃, BST, PLZT, BTO, ferrite and garnet etc., as well as host nano-oxide matrix such as Si, GaAs, and CdTe, etc., may be used without departing from the scope of the invention. Still further, some alloy nano-metal magnetic particles such as NiFe, CoPt, and FePt, etc., as well as composite of nano-magnetic oxide particles and nano-magnetic metal particles may also be used without departing from the scope of the invention.

Optical transparency and the magneto-optic effect of the magnetic nanocomposite layer may include ultraviolet, violet, visible, infrared, far-infrared and millimeter wave with dependence on optical transparency of host matrix, but are not limited thereto.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A system for generating a nanocomposite layer on a substrate, comprising:
an aerosol chamber configured to accept a carrier gas and a powder of a sub-micron size, and to generate an aerosol; and
a deposition chamber configured to accelerate said aerosol via a nozzle to solidify onto a substrate and produce a film that includes fine crystal grains without any pores, having a size of tens of nanometers, wherein said deposition chamber operates at room temperature.

2. The system of claim 1, wherein a composition of said powder does not change before and after said deposition.

3. The system of claim 1, wherein said film is a transparent magneto-optic layer.

4. The system of claim 1, wherein said film is a transparent magnetic composite layer with embedded nanoparticles in a matrix.

5. The system of claim 1, wherein said nanoparticles are fixed via thermal annealing.

6. The system of claim 1, further comprising a mass flow controller positioned between said aerosol chamber and a gas cylinder that stores said carrier gas; and
a filter and classificator positioned between said aerosol chamber and said deposition chamber.

7. The system of claim 1, wherein said particles have a size from about 5 nm to about 500 nm and are applied in a dielectric matrix.

8. The system of claim 1, wherein said raw powder comprises at least one nanomagnetic particle and at least one host matrix, which are mixed to generate a composite powder of said aerosol.

9. The system of claim 8, wherein said at least one composite powder comprises PZT and said at least one nanomagnetic particle comprises cobalt.

10. The system of claim 8, wherein said at least one composite nanomagnetic particle comprises PZT and said at least one nanomagnetic particle comprises a metal selected from the group consisting of cobalt, iron, nickel and manganese of less than 10% by weight, and said at least one composite powder comprises at least one of a host nano-oxide matrix, an alloy nano-metal magnetic particle, and a combination thereof.

11. A method of forming a nanocomposite layer on a substrate, comprising:
mixing a carrier gas and a powder of sub-micron size to generate an aerosol; and
accelerating and depositing said aerosol to solidify onto a substrate and produce a film that includes fine crystal grains without any pores, having a size of tens of nanometers, wherein said deposition chamber operates at room temperature.

12. The method of claim 11, wherein a composition of said powder does not change before and after said depositing.

13. The method of claim 11, wherein said film is a transparent magneto-optic layer.

14. The method of claim 11, wherein said film is a transparent magnetic composite layer with embedded nanoparticles in a matrix.

15. The method of claim 14, further comprising thermal annealing to fix said nanoparticles.

16. The method of claim 11, further comprising controlling a supply of said carrier gas via a mass flow controller positioned between said aerosol chamber and a gas cylinder, wherein a filter and classificator are positioned between said aerosol chamber and said deposition chamber.

17. The method of claim 11, wherein said particles have a size from about 5 nm to about 500 nm and are applied in a dielectric matrix.

18. The method of claim 11, further comprising mixing said raw powder comprising at least one nanomagnetic particle and at least one host matrix, to generate a composite powder of said aerosol.

19. The method of claim 18, wherein said at least one composite powder comprises PZT and said at least one nanomagnetic particle comprises cobalt.

20. The method of claim 18, wherein said at least one composite nanomagnetic particle comprises PZT and said at least one nanomagnetic particle comprises a metal selected from the group consisting of cobalt, iron, nickel and manganese of less than 10% by weight, and said at least one composite powder comprises at least one of a host nano-oxide matrix, an alloy nano-metal magnetic particle, and a combination thereof.
